(19) United States
(12) Patent Application Publication
(10) Pub. No.: US 2016/0019637 A1
(43) Pub. Date: Jan. 21, 2016

(54) COLLECTIVE NETWORK PURCHASING (CNP) SYSTEM

(71) Applicants: Ronald R. Harris, JR., Dundee, MI (US); Travis R. Brown, Temperance, MI (US)

(72) Inventors: Ronald R. Harris, JR., Dundee, MI (US); Travis R. Brown, Temperance, MI (US)

(21) Appl. No.: 14/799,993

(22) Filed: Jul. 15, 2015

Related U.S. Application Data
(60) Provisional application No. 62/025,230, filed on Jul. 16, 2014.

(51) Int. Cl. G06Q 30/08

(52) U.S. Cl. CPC G06Q 30/08

(57) ABSTRACT

A collective network purchasing (CNP) website is disclosed, via which bidding processes are performed for items available for collective purchasing. The bidding processes include receiving bids from CNP members, and deducting each bid from a purchased balance of the bidding CNP member and adding the bid to a cumulative number of bids for the bid-upon item. The CNP website converts an item available for collective purchasing to a collectively purchased item in response to the cumulative number of bids for the item reaching a value assigned to the item. The converting including assigning ownership of the collectively purchased item to a last-acting CNP member in the bidding process for the item.

This application claims the benefit of U.S. Provisional Application No. 62/025,230 filed Jul. 16, 2014 titled “Collective Network Purchasing (CNP) System”, and is incorporated herein by reference in its entirety.

### BACKGROUND

The following relates to the retail arts, auctioneering arts, and related arts, and to online electronic systems, devices, and methods relating to same.

Various retail approaches are known. With a retail websites or stores, an item is purchased for an advertised price. The customer must pay the advertised retail price. The customer may purchase the item while on sale, but there is still a fixed (sale) price for the product, which must be set high enough for the seller to make a profit (except perhaps for an occasional “loss leader” product that is sold at a loss to attract customers). It follows that in a conventional retail setting, the customer rarely has the opportunity to purchase an item at far below its reasonable retail value.

Those seeking a better value proposition may instead participate in a conventional auction or auction website. While the auction process varies, conventionally each auction participant bids against other participants. The price rises with each successive bid until it reaches a value large enough that no participant is willing to bid higher. A good deal can be obtained in a conventional auction, but only in those cases in which one participant values an item significantly higher than all other participants, so that no one bids up the one participant's initial low bid. More commonly, at least some auction participants are cognizant of the reasonable retail value of the item, and will bid up the price at least until it approaches this reasonable retail value. In some cases, emotions take over and two or more participants enter into a “bidding war” that can drive the price for an auction item to a value that is well above its reasonable retail value.

Beyond the pure value proposition, many auction participants enjoy the excitement engendered by the uncertainty of the auction setting, that is, by the chance (however low it may be in actuality) of obtaining an item at an exceptionally low price. Purchasing an item at a set retail price usually does not generate this kind of excitement.

On the other hand, from the seller's perspective, the retail approach is advantageous because it provides certainty as to the price obtained for an item. By contrast, an auction provides less certainty—the payout may be well above the reasonable retail price in the case of a bidding war, or may be very low if the item does not generate a high number of bids. The risk of a low final bid can be partially offset by setting a minimum price, i.e. “reserve” price, so that the item is not sold if the final bid is below the reserve price—but if the reserve price is set too close to the reasonable retail value then auction participants are deprived of the motivating potential for obtaining a bargain.

Auctions are not particularly effective for selling mass produced items, and tend to be mostly used for selling unique items. For mass produced items, a bidding war is unlikely since there are many opportunities to purchase the mass produced item. Thus, mass produced items are usually sold by way of the retail model, and it is rare for the customer to obtain an exceptional deal for a mass produced item either by either of the retail or auction pathways.

Some improvements are disclosed herein.

### BRIEF DESCRIPTION

In some illustrative embodiments, a server computer hosting a collective network purchasing (CNP) website is disclosed. The server computer is programmed to operate in conjunction with electronic client devices to perform operations as follows. A value and a cumulative number of bids associated with each item available for collective purchasing are stored. Accounts for CNP members are stored, wherein each account includes a balance of tickets purchased by the CNP member. A board of one or more available items is displayed on an electronic client device. A bid on an available item of interest to a bidding CNP member is received via an electronic client device operated by the bidding CNP member, and in response to receiving the bid: the balance of tickets of the bidding CNP member is decreased in accord with the received bid; the cumulative number of bids associated with the available item of interest is increased in accord with the received bid; and peek information including at least the cumulative number of bids associated with the available item of interest is displayed on the electronic client device operated by the bidding CNP member. An available item is converted to a collectively purchased item. This conversion includes assigning ownership of the collectively purchased item to a winning CNP member whose last action received via an electronic client device operated by the winning CNP member caused the cumulative number of bids associated with the collectively purchased item to reach the value associated with the collectively purchased item.

In some illustrative embodiments, a collective network purchasing (CNP) method is performed using a website and an electronic network. The CNP method comprises receiving bids via electronic client devices for items available for collective purchasing and, in response to each bid: decreasing a balance of tickets purchased by the bidding CNP member in accord with the received bid; increasing a cumulative number of bids for the item for which the bid was received; and displaying, via the electronic client device operated by the bidding CNP member, peek information including at least the cumulative number of bids for the item for which the bid was received. The CNP method further comprises assigning ownership of a collectively purchased item to a winning CNP member whose last action caused the cumulative number of bids for the collectively purchased item to increase to a value assigned to the collectively purchased item.

In some illustrative embodiments, a collective network purchasing (CNP) website comprises a server computer. The CNP website performs operations comprising: performing bidding processes for items available for collective purchasing including (i) receiving bids from CNP members and (ii) deducting each bid from the a purchased balance of the bidding CNP member and adding the bid to a cumulative number of bids for the bid-upon item; and converting an item available for collective purchasing to a collectively purchased item in response to the cumulative number of bids for the item reaching a value assigned to the item, the converting including assigning ownership of the collectively purchased item to a last-acting CNP member in the bidding process for the item.

One advantage of the disclosed collective network purchasing (CNP) is that the seller is provided with a predetermined fixed compensation for an item.

Another advantage of the disclosed CNP is that the buyer is provided with the chance to acquire an item at far below its reasonable retail value.

Another advantage of the disclosed CNP resides in providing for the sale of an item with both predetermined fixed compensation for the seller and the chance for the buyer to acquire the item at far below its reasonable retail value.

Another advantage of the disclosed CNP resides in providing the buyer with an exciting buying experience by introducing the chance of acquiring an item at an exceptional value into the buying process, while still providing the seller with a predetermined fixed compensation for the item.

Yet another advantage of the disclosed CNP is that it is well-suited for selling mass produced items while still retaining the element of providing the buyer with the chance to obtain the item at far below its reasonable retail value.

These and other advantages of the disclosed CNP will be appreciated by those of ordinary skill in the art upon reading and understand the following detailed description. A given embodiment may achieve none, one, more, or all of these advantages.

### BRIEF DESCRIPTION OF THE DRAWINGS

FIG. 1 diagrammatically shows a collective network purchasing (CNP) system as described herein.

FIG. 2 diagrammatically shows an item selection board displayed on a user interface device of the CNP system of FIG. 1.

FIG. 3-6 diagrammatically show successive displays presented on a user interface device of the CNP system of FIG. 1 during an illustrative bidding process described herein.

### DETAILED DESCRIPTION

Disclosed herein are Collective Network Purchasing (CNP) systems and methods. In CNP, a collective network of people contribute to purchasing a single item, with intent (or consequence) of sole ownership by one. In illustrative embodiments, CNP is implemented in an Internet based setting, using a website, mobile device application (“app”), or so forth, and the people of the illustrative collective network are referred to herein as “users” or “members” (since a form of membership in the CNP is typically employed to ensure personal identification). Items are displayed on a website (or via an app or other user interfacing device), and the items have no monetary value showing. Each item has a button below it (or otherwise arranged associated with the item) that can be clicked using a pointing device or otherwise selected by a user. In illustrative embodiments, this button is referred to as a “peek” button. Each click on the peek button is worth one “bid”. Once a member has purchased a “peek” a window pops up with the “value” of the item and the current placing of the member in the value of the item, example 400 (ranking of member) out of 1000 (value). The member who makes the final bid (for example, bid 1000 out of a value of 1000) thereby acquires ownership of the item, which may for example then be shipped directly to the member's address that was provided during the membership sign up process. In the illustrative embodiment, all taxes and shipping and handling are paid by the website (alternatively, these may be assessed to the “winning” member who acquires the item).

In one embodiment, items are purchased retail and re-sold for profit. Each item is assigned a set number of “bids” it can be purchased for. The person to make the last bid will acquire ownership of the product. The set number of bids will be assessed for each individual item before it is made available for purchase. Alternatively, items may be bought at wholesale and sold for profit. Each item again is assigned a set number of “bids” it can be purchased for. The person to make the last bid will acquire ownership of the product. The set number of bids is assessed for each individual item before it is made available for purchase.

Items are displayed without a monetary value or the number of bids (or tickets) already placed showing. A member purchases a “peek” with one “bid” or ticket in order to see the value of the item and see where in line the member now stands as a potential buyer. Should a member buy a “peek” and be the final bid or ticket reaching the assigned “value” of the item, that person acquires ownership of the item.

The CNP may be implemented using a website model. To access the website and be able to start bidding on items, an individual first signs up for a membership. After signing up, the person (now a “member”) can then purchase “bids” (or “tickets”). After purchasing bids, the member can proceed to bid on any item available on the website. The last person to make the final bid for an item will acquire ownership of the item.

In one non-limiting illustrative example, bids are purchased by members with each bid equal to the value of $0.10; of course, other values for bids are contemplated. Membership provides access to buy “bids” and to try to buy items on the website. Obtaining membership may entail filling out a membership application including but not limited to; Name, address, email, phone number, and/or so forth. The standard member information should be sufficient to enable the member to be identified (e.g. name), to be contacted (e.g. email address, telephone number), and to enable an acquired item to be shipped to the member (e.g. shipping address). In one embodiment, any applicable taxes are included in the value of each item. In another embodiment, any sales tax is paid by final bidder/ticket purchaser. In one embodiment, any shipping and handling charges are included in “value” of each item. In another embodiment any shipping and handling are paid by final bidder/ticket purchaser.

In one non-limiting illustrative example, three options are provided for shipping an item: free standard shipping (i.e., shipping cost covered by the CNP provider); two-day shipping or overnight shipping, each of which has an added cost to the buyer and is paid at the time of checkout. In one contemplated implementation, if an item that is shipped is undeliverable for any reason, one attempt is made to contact the buyer via email or by telephone. Upon contact the member is given 48 hours to respond in order to claim the purchase. If no response is provided, or the contact information fields were left blank on the membership application, then the item is forfeited and the returned item is donated to a charity or otherwise disposed of. There are merely illustrative contemplated shipping options and terms, and additional/other options/terms are contemplated.

In one non-limiting illustrative contemplated implementation, members are provided with two options to install funds into their account: either by debit/credit card, or pre-paid card. Deposited funds are converted into bids. Once the funds are deposited in the member's account they cannot be withdrawn. Each member's account will display the amount in dollars and in available bids. If a member uses the “fill it up” option and cannot pay for the item, that member's membership is red-flagged. If this happens to a member that already has a red-flagged account, the member's membership is revoked indefinitely. Any bids left in a member's account must be used within 24 hours or they will be forfeited. These are merely illustrative terms of use, and additional/other terms of use are contemplated, for example: other payment methods may be provided; the account balance may optionally be displayed only in bids or tickets (without a dollar amount) or a different currency may be used (e.g. euros); the consequence of selecting “fill it up” with an insufficient balance may be different (e.g. the selection may simply be denied via a pop-up window telling the member he/she has insufficient funds); bids may optionally remain in a member's account indefinitely and/or may optionally be cashed out; et cetera.

In the CNP, a “peek” is purchased by a member making a “bid” on an item. Each peek provides the bidding member with information including the value of the item (e.g. measured as a total number of bids) and the current place at which the member's bid/peek was purchased. For example, in response to a bid the bidding member may be provided with peek information as, e.g. “100 out of 4000” where “100” is the current bid total and “4000” is the total number of bids at which the item is acquired. Other terms may be used for these features—for example, a “bid” may alternatively be referred to as a “ticket”. In another suitable nomenclature, the member buys tickets and makes a bid by applying a ticket to an item. The “value” of an item is the set (i.e. predetermined and fixed) number of “bids” or “tickets” that will be needed to be made on the item in order to acquire an item (i.e. “purchase” an item, where “purchase” is used loosely to indicate the member who makes the final bid reaching the value for the item thereby acquiring the item).

In one suitable website configuration, a “TRY TO BUY” button is displayed after an item has reached its financial obligation to be bought at its remaining balance. This button will appear in the peek information window.

In an illustrative CNP scenario, a member logs into his or her account on the CNP website. The member may purchase as many bids (or tickets) as desired, which are kept in the member's account until used. Once the member has bids (tickets) in his or her account, the homepage is displayed, which presents items that are available to bid on. The member may choose an item of interest and click on the peek button of that item. After clicking on the peek button, a window pops up with information on it, including the number of bids already placed and the member's current placement in the previously set number of bids the item will sell for (i.e., the “value” of the item, e.g. “1000 out of 5000” indicating the value is 5000 and the member's bid was bid number 1000 on this item). From this point, the member can strategically time his or her next bid with the goal of being the last bidder on an item.

In some variant embodiments (or for some items of a given embodiment), once the number of bids for an item has reached a pre-defined threshold (such as 50% of bids to reach the value) the peek display further includes an option to “try to buy” (e.g. a button labeled “TRY TO BUY”). The peek view information further provides the remaining balance (e.g. “2500 out of 5000, 2500 bids remaining to buy”). Should the member want to, he or she can click on the “TRY TO BUY” button in the peek view (once the number of bids reaches the threshold for display of that button) in order to try to buy the item.

In the CNP approach, an item is paid for by multiple people (CNP members), but possession of the item is acquired by one member. Ownership is decided in CNP by what is referred to herein as “last-to-act”. CNP may be used to acquire (loosely, “purchase”) items (e.g. products or services), whose value may be set in the CNP paradigm at a wholesale or retail value. Membership in the CNP system is optionally free, or there may be some membership fee charged one-time at signup, or annually etc. After becoming a member (and optionally upon financial approval), members are able “try-to-buy” item(s) by bidding (e.g. using bids or tickets each having a value of $0.10 or some other set bid/ticket value). Each item is assigned a “value”, which is a designated number of bids required to purchase the item. Once the number of bids for the item reaches this value, the item is sold. In some embodiments, there are two ways for the bids to reach the value level. In one way, bids are submitted one bid at a time until the last bid is applied to that item which reaches the value level. In another way, an individual pays for the balance of remaining unfulfilled bids for that item in order to acquire it. By way of illustration, the first 50% of the bids may be applied to an item to cover the cost of a markup. Once the markup is covered, every subsequent bid applied to the item will lower the remaining balance of the item by $0.10 each time. From that point forward bidding members will be allowed to purchase the item for the balance at that time. The markup will cover the costs of shipping, taxes and operating expenses.

The approach in which the member pays for the balance of remaining unfulfilled bids for that item in order to acquire it is also referred to herein as “fill it up” (because the member instantly “fills up” the remaining bids in order to reach the value level). A “fill it up” button displays the amount of bids remaining to acquire (i.e. “purchase”) the item. Clicking on the “fill it up” button allows the member to fulfill the balance of the financial obligation, thus, being “last to act” and thereby acquiring the item. The “fill it up” button is displayed as part of the “peek” information (e.g. peek pop-up window or information cloud) that is displayed when a member submits a bid. The “fill it up” button is displayed as part of the peek information once collectively the markup of an item (or other chosen threshold for permitting the fill it up option) is covered. By clicking on the “fill it up” button the member pays (or agrees to pay) the remaining balance on the item. If the member has enough bids in his or her account to “fill it up” i.e. pay off the remaining bids to reach the value level, then the transaction is automatically completed. If the member does not have enough bids in his or her account to complete the “fill it up” option, the member is directed to a checkout page to purchase the required number of bids/tickets. (Alternatively, a message may come up in response to clicking the “fill it up” button informing the member his account balance is insufficient, in which case the member would need to go to another page, e.g. an account balance page, and first buy a sufficient number of bids/tickets and then try to “fill it up” again).

In the CNP context, the “last to act” principle determines which member acquires possession of an item. By clicking on the “fill it up” button, this allows a member to purchase the item by paying for the remaining balance or, the member may acquire the item by being the last to fulfill the financial obligation (i.e. the value of the item) by applying the last bid.

Various approaches may be employed for obtaining items to be offered on the CNP website. In one approach suitable for mass produced items (which also includes generally available services, e.g. a tropical cruise having a large number of berths available), the website items are not owned or stocked by the CNP website provider; rather, once the purchasing process is completed, the CNP website provider purchases the item from a non-disclosed commercial retailer. This approach advantageously reduces warehousing costs. In another contemplated approach, the CNP website provider does acquire and warehouse the items offered on the CNP website. In yet another contemplated approach, the CNP website provider is also a commercial retailer and already has the items in stock. Payment for items (or, more specifically, for purchased bids/tickets) may be suitably made using any commercial transaction instrument, e.g. a credit card, debit card, pre-paid card, or so forth.

With the CNP approach, the price of an item goes down over time (instead of up in time as in a conventional auction). Items at first are offered at full price, and the price goes down from there. As bids are applied by members “trying to buy” the item, the bids reduce the remaining price left on the item. Through the process of occasionally applying a bid to an item a member is able to monitor the balance of the item, and that balance is lower each time the member bids.

In some contemplated CNP implementations, a goal is to keep the purchase price around 10%-15% of the average retail purchase price. If this starts to rise the CNP website provider adds more of the same product (assuming here a mass produced item). Instead of one item there would be multiple instances of the same item (e.g., ten tablet computers of the same brand). This spreads out the potential buyers and keeps the purchase price within that projected range.

It is contemplated for the CNP website to include a “Member requests” page, via which members are able to request items to sell. Upon receiving requests and reviewing items they will be considered and may be added to the CNP website.

In another contemplated variant, promotional “chips” may be distributed in some instances. Each promotional chip may, for example, be a standard poker chip with the CNP website name on one side of the chip and a promotional code on the other side of the chip. Each promotional chip will have a different code. The promotional chips are contemplated to be offered in different color sets, with each color having, for example, 200 chips in its set. Each promotional chip will have a predetermined value, e.g. one bid or ten bids. When the promotional code is first used, it may be used at any time on any item. Periodically, the CNP website announces promotional color days. On these days for the color announced there will be a window of time where the promotional codes for that color set are activated. During this window of time members are allowed to apply bids to any item. After the window of time expires, the promotional codes will become inactive. Unused bids during this time are forfeited and cannot be saved or added to the next or any other promotional color days.

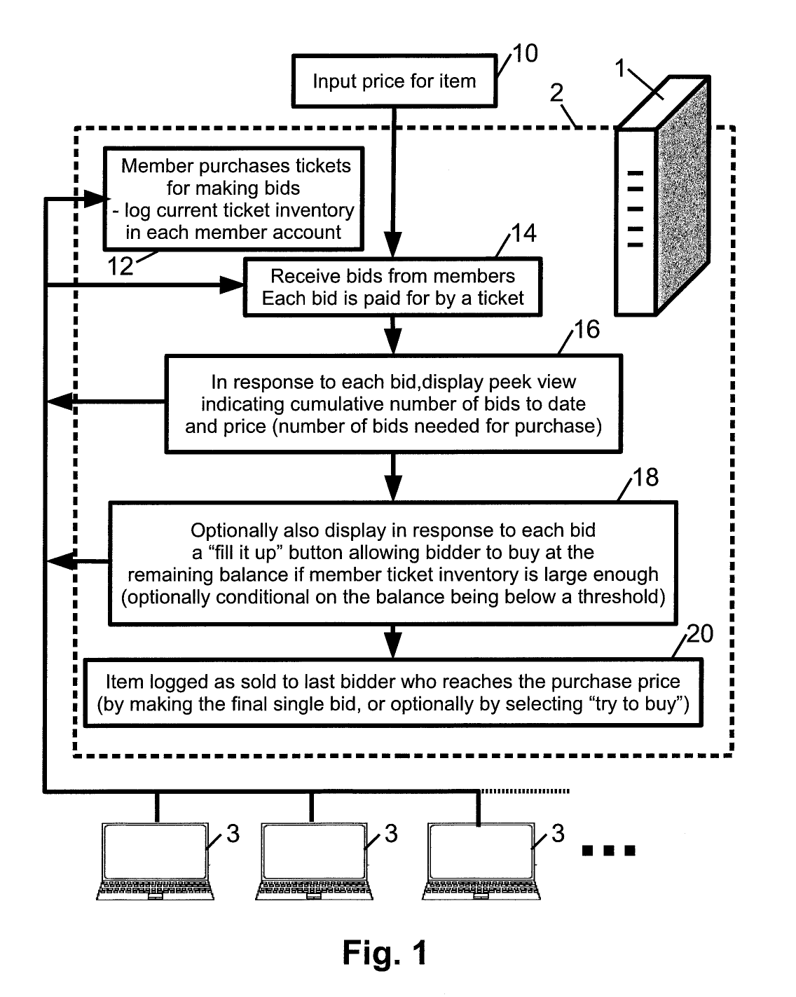

With reference now to FIG. 1, a server computer 1 hosts a collective network purchasing (CNP) system (e.g. website) 2. The server 1 may be a single Internet-based server, a cloud computing resource comprising a plurality of server computers interconnected by the Internet and/or a dedicated server network, or so forth. Electronic client devices 3 operated by CNP members enable CNP members to interact with the CNP website 2 via the Internet and/or other electronic network(s). The illustrative electronic client devices 3 are computers, but more generally the electronic client devices 3 may be personal computers, smartphones or other mobile devices, or so forth.

Each item available for collective purchasing on the CNP website 2 is assigned an input price or value 10, typically in bid units, i.e. a certain number of bids which must be made for the item in order for the last-acting CNP member to acquire the item. As previously noted, there is no requirement that the item actually be available in a warehouse of the CNP website provider—rather, in some embodiments a “just-in-time” purchasing model is employed in which the item is purchased from a conventional retailer for delivery to the last-acting CNP member in the bidding process. Moreover, the item available for collective purchasing may be a service such as a tropical cruise berth.

In order to use make bids, CNP members purchase tickets 12 for making bids. The current ticket inventory (i.e. ticket balance) for each member is stored in the member's account on the CNP website 2. In an operation 14, bids are received from CNP members for bid-upon items. Each bid is paid for by a ticket from the CNP member's ticket inventory, i.e. balance of tickets—that is, the balance of tickets for the bidding CNP member is decreased in accordance with the bid. In illustrative examples herein, there is a one-to-one correspondence between purchased tickets and bids, so that each bid decreases the bidding CNP member's balance of tickets by one. However, other correspondences are contemplated, e.g. each ticket may correspond to ten bids in which case the balance of tickets is not necessarily a whole number.

In an operation 16, in response to each bid the cumulative number of bids for the bid-upon item is increased as the bid is added to the cumulative number of bids for the bi-upon item, and a peek view is displayed which in the illustrative embodiment includes the cumulative number of bids and the item value (i.e. the item “price” input in operation 10). In the illustrative embodiments, the item value is displayed only in the peek view along with the cumulative number of bids; in other embodiments, the item value may be displayed along with the item, even without making a bid.

In CNP embodiments which provide the “fill-it-up” user input (e.g. fill-it-up button), this is also displayed in the peek view in an optional operation 18. Selection of the fill-it-up user input allows the bidding CNP member to buy the item at the remaining balance (that is, the difference between the item value and the cumulative number of bids for the item at the time of fill-it-up selection) if member ticket inventory is large enough. Optionally, the fill-it-up user input is displayed only if the balance is below a threshold (or, stated another way, only if the cumulative number of bids is equal to or above a threshold).

In an operation 20, the bidding process is completed by a last-acting CNP member, who is therefore the winning CNP member. The last action by the last-acting CNP member may be a last bid which when added to the cumulative number of bids reaches the item value. In embodiments including a fill-it-up user input, the last action by the last-acting CNP member may alternatively be selection of the fill-it-up user input, in response to which the difference between the item value and the cumulative number of bids for the item at the time of fill-it-up selection is deducted from the balance of tickets of the winning CNP member. The operation 20 assigns ownership of the item to the winning CNP member. (Preferably, the operation 20 includes some mechanism to prevent a situation in which a CNP member fills it up without having a sufficient balance, for example an initial check of the CNP member's ticket balance may be performed, and the fill-it-up request may be denied if the balance is insufficient to cover the balance, i.e. the difference between the item value and the cumulative number of bids for the item).

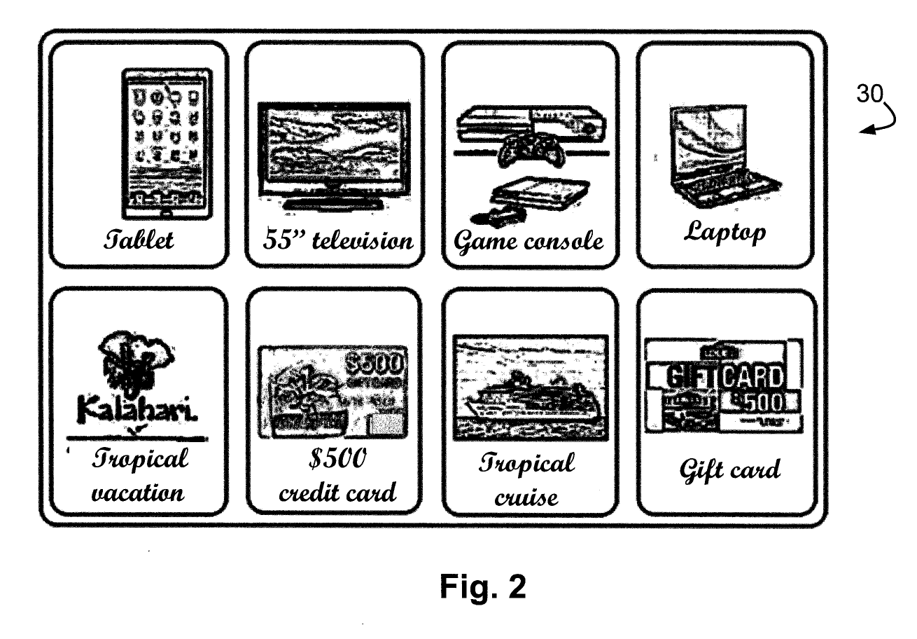

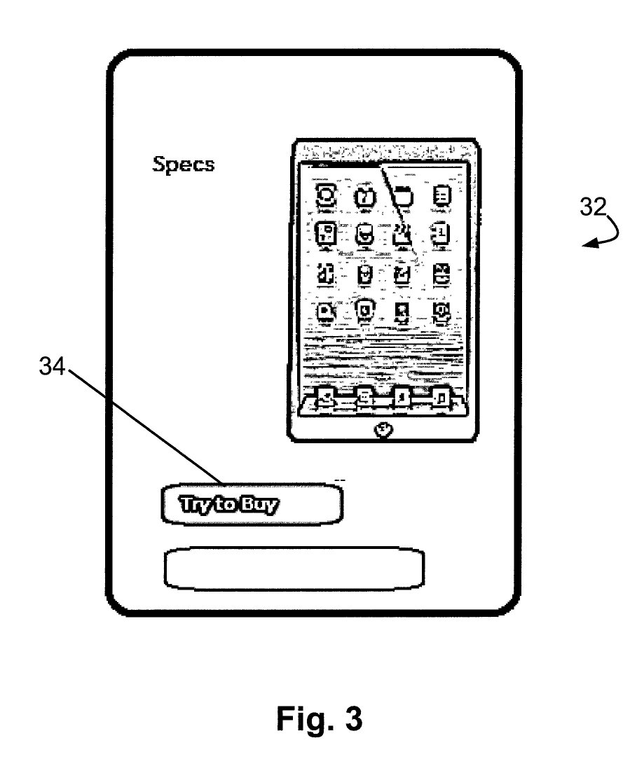

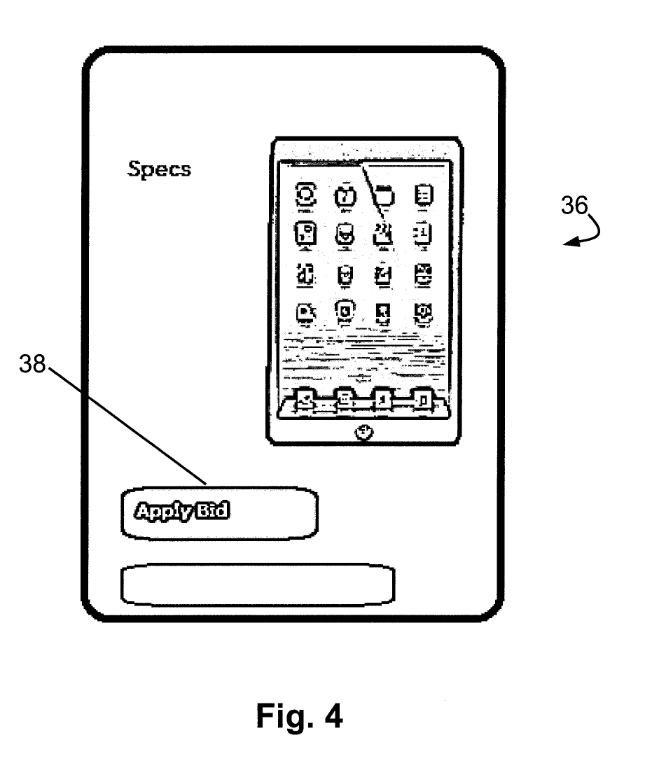

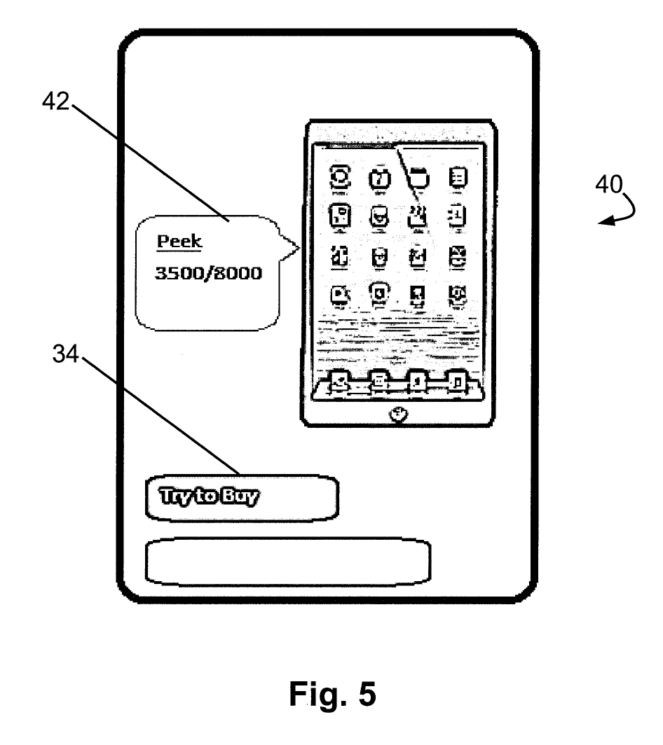

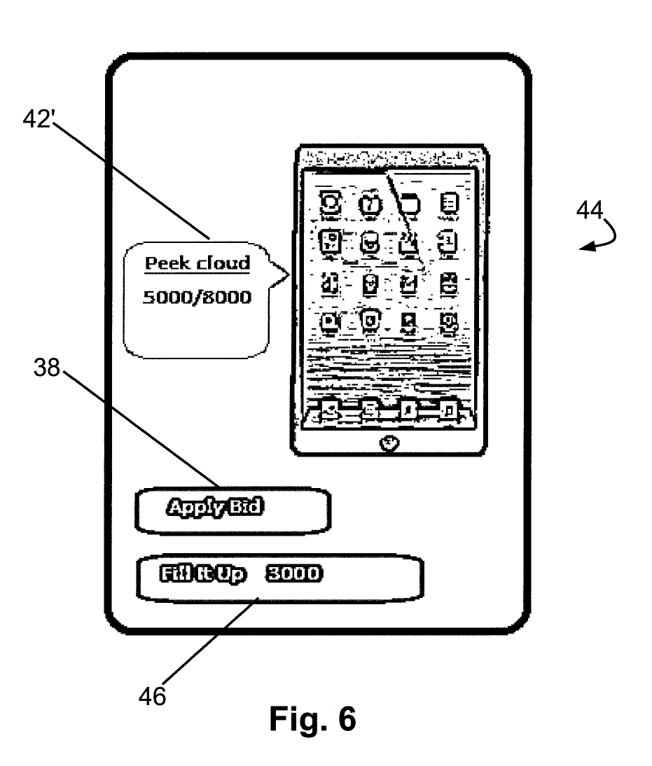

With continuing reference to FIG. 1 and with further reference to FIGS. 2-6, an illustrative example is described of a portion of a bidding process for an item, namely a tablet computer. As shown in FIG. 2, a CNP member operating an electronic client device 3 is presented via the electronic client device 3 with a board 30 of one or more available items. The illustrative board 30 shows eight available items, including a tablet, a 55″ television, a game console, a laptop computer, a tropical vacation, a $500 pre-paid credit card, a tropical cruise berth, and a $500 gift card. These are merely illustrative examples. It will be appreciated that a given board may display fewer than all available items, and may display as few as a single available item. Preferably, the CNP website 2 provides conventional tools for filtering and/or sorting and/or searching the items in order for the CNP member to locate an item of particular interest to that CNP member. In the illustrative example of FIGS. 2-6, the CNP member selects the tablet, which brings up the display 32 of FIG. 3 on the electronic client device 3, showing an image of the tablet along with listed specifications (diagrammatically indicated in FIG. 3 as “Specs”). A “try-to-buy” button 34 is also displayed. (Alternatively, this button 34 could be otherwise-labeled, e.g. as “apply bid”). If the CNP member wishes to bid on the tablet, he or she selects the “try-to-buy” button 34 which brings up the display 36 of FIG. 4 which is similar to the display 32 except that the “try-to-buy” button 34 is now replaced by an “apply bid” button 38. This is an optional bid confirmation step intended to reduce the likelihood of the CNP member making an inadvertent bid. If the “apply bid” button 38 is selected to confirm the bid, this brings up the display 40 of FIG. 5 which includes the peek view 42. In the illustrative example of FIG. 5, the cumulative number of bids (incremented to account for the immediate bid made by the CNP member via the display 36 of FIG. 4) is 3500, while the value of the tablet assigned in the operation 10 (see FIG. 1) is 8000—the illustrative peek view displays this information as “3500/8000”. The display of FIG. 5 also includes the “try to buy” button 34 via which the CNP member can choose to make a further bid. As further bids are made, the cumulative number of bids shown in the peek view is updated accordingly. With reference to FIG. 6, a display 44 after at least one additional bid shows updated peek information “5000/8000” 42′ indicating the cumulative number of bids is now up to 5000. Additionally, this cumulative number of bids is equal to or greater than a “fill it up” threshold chosen for the item (illustrative table), and accordingly a fill-it-up user input (e.g. button) 46 is also shown in the display 44. This corresponds to the operation 18 of FIG. 1. The illustrative fill-it-up button 46 is also labeled with the value “3000”, which is the fill-it-up balance, i.e. the difference between the tablet value (8000 bid units) and the cumulative number of bids (5000) at the time of selection of the fill-it-up button 46. If the CNP member selects the fill-it-up button 46 then this difference of 3000 bids is deducted from the CNP member's balance of tickets, and the tablet is converted from an item available for collective purchasing to a collectively purchased item whose ownership is assigned to the last-acting CNP user who selected the fill-it-up button 46.

It will be appreciated that the illustrative embodiments are merely examples, and that numerous modifications can be made while remaining within the scope of the disclosed CNP systems and methods. For example, various user inputs may be substituted for the illustrative buttons 34, 38, 46, e.g. various graphical user interface (GUI) user interfacing elements may be used. While in the illustrative embodiment the item value (e.g. 8000 bid units for the illustrative tablet) is displayed only as part of the peek information 42, 42′, it is alternatively contemplated to display the item value anytime the item is displayed (e.g. on the board 30 of FIG. 1, or in the display 32). On the other hand, the cumulative number of bids is preferably displayed only as part of the peek information, since receiving this information via the peek view 42, 42′ is part of the incentive for a CNP member to make a bid.

In the illustrative embodiments, the items available for collective purchasing are mass-produced items, which are generally available in new condition in large quantities. However, the disclosed CNP is also applicable to selling used items, collectable items (e.g. antiques), and other types of items that may be available on a limited basis, or that may even be unique items. For example, the CNP website could have a “used products” section where members can re-sell pre-owned products using the CNP paradigm.

Moreover, it will be appreciated that phraseology employed herein is merely illustrative in nature, and different terms can be used for the various features. For example, the “try-to-buy” button 34 can be otherwise labeled, e.g. as “bid for item”, or “bid and view current bids total”, or so forth. The “peek” view 42, 42′ may likewise be otherwise labeled, e.g. as the “Current number of bids”, and may be otherwise formulated, e.g. rather than displaying the cumulative number of bids the number of bids remaining could instead be displayed, e.g. in FIG. 5 the peek view 42 could instead read “8000 bids to buy—4500 bids remaining” or so forth. In another contemplated embodiment, the peek view is displayed graphically, e.g. as a graph of the cumulative number of bids over the time interval since the item was first available for bidding, so that the member can observe graphically the bidding interest over time. The “fill-it-up” button 46 could similarly be otherwise labeled, e.g. as a “Pay <$> bids now to buy” where “<$>” is a placeholder for the actual number of remaining bids to buy (<$> is replaced by 3000 in the example of FIG. 6).

It will be appreciated that various of the above-disclosed and other features and functions, or alternatives thereof, may be desirably combined into many other different systems or applications. It will be further appreciated that various presently unforeseen or unanticipated alternatives, modifications, variations or improvements therein may be subsequently made by those skilled in the art which are also intended to be encompassed by the following claims.

1. A server computer hosting a collective network purchasing (CNP) website, the server computer programmed to operate in conjunction with electronic client devices to perform operations comprising:
storing a value and a cumulative number of bids associated with each item available for collective purchasing;
storing accounts for CNP members wherein each account includes a balance of tickets purchased by the CNP member;
displaying a board of one or more available items on an electronic client device;
receiving a bid on an available item of interest to a bidding CNP member via an electronic client device operated by the bidding CNP member and in response to receiving the bid:
decreasing the balance of tickets of the bidding CNP member in accord with the received bid,
increasing the cumulative number of bids associated with the available item of interest in accord with the received bid, and
displaying, on the electronic client device operated by the bidding CNP member, peek information including at least the cumulative number of bids associated with the available item of interest; and
converting an available item to a collectively purchased item including assigning ownership of the collectively purchased item to a winning CNP member whose last action received via an electronic client device operated by the winning CNP member caused the cumulative number of bids associated with the collectively purchased item to reach the value associated with the collectively purchased item.

2. The server computer hosting the CNP web site of claim 1 wherein the last action comprises:
a bid received via the electronic client device operated by the winning CNP member that increased the cumulative number of bids associated with the collectively purchased item to the value associated with the collectively purchased item.

3. The server computer hosting the CNP website of claim 1 wherein the last action of the winning CNP member comprises:
selection by the winning CNP member of a fill-it-up user input displayed as part of the peek information on the electronic client device operated by the winning CNP member in response to a bid received via the electronic client device operated by the winning CNP member;
wherein the server computer is programmed to respond to the selection of the fill-it-up user input by operations including:
decreasing the balance of tickets of the winning CNP member in accord with a difference between the value of the collectively purchased item and the cumulative number of bids associated with the collectively purchased item at the time of the selecting, and
assigning ownership of the collectively purchased item to the winning CNP member.

4. The server computer hosting the CNP website of claim 3 wherein the peek information displayed in response to receiving a bid further includes the fill-it-up user input displayed conditional on the cumulative number of bids associated with the available item of interest equaling or exceeding a threshold.

5. The server computer hosting the CNP website of claim 1 wherein the operation of displaying a board of one or more available items on an electronic client device comprises:
displaying the board of one or more available items without showing the cumulative number of bids associated with each available item.

6. The server computer hosting the CNP website of claim 5 wherein the operation of displaying peek information comprises displaying the peek information only for a finite time interval.

7. The server computer hosting the CNP website of claim 1 wherein the available items include at least one of products and services.

8. The server computer hosting the CNP website of claim 1 wherein the operation of storing a value and a cumulative number of bids associated with each item available for collective purchasing includes storing a value in units of bids associated with each available item.

9. A collective network purchasing (CNP) method performed using a website and an electronic network, the CNP method comprising:
receiving bids via electronic client devices for items available for collective purchasing and, in response to each bid:
decreasing a balance of tickets purchased by the bidding CNP member in accord with the received bid,
increasing a cumulative number of bids for the item for which the bid was received, and
displaying, via the electronic client device operated by the bidding CNP member, peek information including at least the cumulative number of bids for the item for which the bid was received; and
assigning ownership of a collectively purchased item to a winning CNP member whose last action caused the cumulative number of bids for the collectively purchased item to increase to a value assigned to the collectively purchased item.

10. The CNP method of claim 9 further comprising:
displaying boards of items available for collective purchasing on electronic client devices, each board presenting one or more items with each item presented without its cumulative number of bids.

11. The CNP method of claim 10 wherein the displaying of peek information is performed only for a finite time interval after which the display of peek information is removed.

12. The CNP method of claim 9 wherein the assigning of ownership comprises:
assigning ownership of the collectively purchased item to the winning CNP member whose last bid caused the cumulative number of bids for the collectively purchased item to increase to the value assigned to the collectively purchased item.

13. The CNP method of claim 9 wherein the assigning of ownership comprises:
assigning ownership of a collectively purchased item to a winning CNP member whose last action causing the cumulative number of bids for the collectively purchased item to increase to the value assigned to the collectively purchased item comprises selecting a fill-it-up button displayed as part of the peek information and the CNP method further include, in response to the selection of the fill-it-up button:
decreasing the balance of tickets of the winning CNP member in accord with a difference between the value assigned to the collectively purchased item and the cumulative number of bids for the collectively purchased item at the time of the selection.

14. The CNP method of claim 13 wherein the fill-it-up button is displayed as part of the peek information only if the cumulative number of bids for the item equals or exceeds a threshold.

15. A collective network purchasing (CNP) website comprising a server computer, the CNP website performing operations comprising:
performing bidding processes for items available for collective purchasing including (i) receiving bids from CNP members and (ii) deducting each bid from a purchased balance of the bidding CNP member and adding the bid to a cumulative number of bids for the bid-upon item; and
converting an item available for collective purchasing to a collectively purchased item in response to the cumulative number of bids for the item reaching a value assigned to the item, the converting including assigning ownership of the collectively purchased item to a last-acting CNP member in the bidding process for the item.

16. The CNP website of claim 15 wherein the server computer is programmed to perform the converting in response to receiving a last bid from the last-acting CNP member in the bidding process wherein the cumulative number of bids with the last bid added reaches the value assigned to the item.

17. The CNP website of claim 15 wherein the server computer is programmed to perform the converting in response to receiving selection of a fill-it-up user input by the last-acting CNP member, the converting in response to receiving selection of a fill-it-up user input by the last-acting CNP member including deducting from the last-acting CNP member's balance a difference between the value assigned to the collectively purchased item and the cumulative number of bids for the collectively purchased item at the time of selection of the fill-it-up user input.

18. The CNP website of claim 17 wherein the server computer is programmed to display the fill-it-up user input for an item only when the cumulative number of bids for the item equals or is greater than a threshold.

19. The CNP website of claim 15 wherein the server computer is programmed to perform the further operation of:
displaying items available for collective purchasing on electronic client devices without displaying the cumulative numbers of bids for the items; and
displaying, in response to receiving a bid from a bidding CNP member and on an electronic client device operated by the bidding CNP member, the cumulative number of bids for the bid-upon item.
